(19) United States
(12) Patent Application Publication
(10) Pub. No.: US 2021/0192321 A1
(43) Pub. Date: Jun. 24, 2021

(54) GENERATION AND UTILIZATION OF CODE CHANGE INTENTS

(71) Applicant: X Development LLC, Mountain View, CA (US)

(72) Inventor: Qianyu Zhang, Sunnyvale, CA (US)

(21) Appl. No.: 16/776,285

(22) Filed: Jan. 29, 2020

Related U.S. Application Data
(60) Provisional application No. 62/949,746, filed on Dec. 18, 2019.

(51) Int. Cl. G06N 3/04; G06F 16/23; G06F 8/71; G06F 8/41

(52) U.S. Cl. CPC G06N 3/0454; G06F 8/427; G06F 8/71; G06F 16/2358

(57) ABSTRACT

Implementations are described herein for learning and utilizing mappings between source code changes and regions of latent space associated with code change intents that motivated those source code changes. In various implementations, data indicative of a change made to source code snippet may be applied as input across a machine learning model to generate a new source code change embedding in a latent space. Reference source code change embedding(s) may be identified in the latent space based on distance(s) between the reference source code change embedding(s) and the new source code change embedding in the latent space. Based on the identified reference embedding(s), code change intent(s) may be identified. Association(s) may be created between the source code snippet and the code change intent(s).

### BACKGROUND

A software system is built upon a source code “base,” which typically depends on and/or incorporates many independent software technologies, such as programming languages (e.g. Java, C++), frameworks, shared libraries, run-time environments, etc. Each software technology may evolve at its own speed, and may include its own branches and/or versions. Each software technology may also depend on various other technologies. Source code bases, or simply “code bases,” tend to be large. There are often teams of programmers and/or engineers involved in updating a large code base in a process that is sometimes referred to as “migrating.”

When a team member makes change(s) to source code file(s) of a code base, they may provide, or may be required to provide, a note indicating an intent (referred to herein as “code change intent” or “change intent”) behind the changes. In version control systems (“VCS”) with atomic multi-change commits, a set of code change(s) and corresponding code change intent(s) that are “committed” to the VCS in a single act may be referred to as a “change list,” a “patch,” a “change set,” or an “update.” Team members may also indicate code change intents using other means, such as comments embedded within source code and delimited from the source code using special characters, such as “//”, “#”, and so forth.

Because they are often under considerable pressure and/or time constraints, code base migration team members may place low priority on composing descriptive change intents, e.g., when they commit updated source code to the code base. For example, different team members may describe vastly different code changes with similar and/or ambiguous code change intents. Likewise, different team members may describe similar code changes with vastly different (at least syntactically) code change intents. Consequently, someone who consults information associated with change list(s) in order to gain a high level understanding of changes made to a code base during a migration may be confronted with numerous change list entries that are repetitive, redundant, vague, and/or ambiguous.

### SUMMARY

Techniques are described herein for learning and utilizing mappings between changes made to source code and regions of latent space associated with source code change intents that motivated those source code changes. In some implementations, one or more machine learning models may be trained to generate embeddings based directly or indirectly on changes made to source code snippets. These embeddings may capture semantic and/or syntactic properties of the source code change(s), as well as aspects the user-provided comments. For example, in some implementations, a “change list” “change set,” “update,” or “patch” may identify changes made to source code during a single commit to a version control system. For example, the change list may include before and after source code snippets (e.g., showing the changes made), as well as one or more human-composed comments (“change list entries”) that explain the intent(s) behind the changes. Various features of the change list, such as changes made, human-composed comments, etc., may be processed to generate an embedding that captures the change(s) made to the source code along with the intent(s) behind the change(s).

In some implementations, these embeddings may take the form of “reference” embeddings that represent previous change lists associated with changes made to source code previously. In some implementations, these reference embeddings map the previous change lists to a latent space. These reference embeddings may then be used to identify change intents for various purposes, such as for presentation as a condensed code base migration summary, for automatic pre-generation of a code change intent for a programmer ready to commit an updated source code snippet to a code base, for locating source code changes based on desired code change intents, and so forth.

As a non-limiting example of how a machine learning model configured with selected aspects of the present disclosure may be trained, in some implementations, a first version source code snippet (e.g., version 1.1.1) may be obtained from a change list and used to generate a data structure such as an abstract syntax tree (“AST”). The AST may represent constructs occurring in the first version source code snippet, such as variables, objects, functions, etc., as well as the syntactic relationships between these components. Another AST may be generated for a second version source code snippet (e.g., 1.1.2), which may be a next version or “iteration” of the first version source code snippet. The two ASTs may then be used to generate one or more data structures, such as one or more change graphs, that represent one or more changes made to update the source code snipped from the first version to the second version. In some implementations, one change graph may be generated for each change to the source code snippet during its evolution from the first version to the second version.

Once the change graph(s) are created, they may be used as training examples for training a machine learning model such as a GNN. In some implementations, the change graph(s) (or embeddings generated therefrom) may be applied as input across the machine learning model to generate corresponding source code change embeddings. In some implementations, the change graph(s) may be labeled with information, such as change intents, that is used to map the changes to respective regions in the latent space. For example, a label “change variable name” may be applied to one change, another label, “change function name,” may be applied to another change, and so on. In some implementations, these labels may be obtained from change list entries provided when the underlying change lists were committed to the VCS, or from comments embedded in source code.

As more and more change graphs are input across the machine learning model, these labels may be used as part of a loss function that determines whether comparable changes are clustering together properly in the latent space. If an embedding generated from a change of a particular change type (e.g., “change variable name”) is not sufficiently proximate to other embeddings of the same change type (e.g., is closer to embeddings of other change types), the machine learning model may be trained, e.g., using techniques such as triplet loss.

This training process may be repeated over numerous training examples until the machine learning model is able to accurately map change graphs, and more generally, data structures representing source code changes, to regions in the latent space near other, syntactically/semantically similar data structures. In some implementations, training techniques such as triplet loss may be employed to ensure that source code changes of the same change intent are mapped more closely to each other than to source code changes of different change intents.

In some implementations, the training process may involve grouping change lists into clusters based on their underlying code change intents that motivated the respective source code changes. In some implementations, natural language processing may be performed on code change intents (e.g., embedded comments, change list entries) to identify change lists having semantically/syntactically similar code change intents. Consequently, each cluster includes any number of different change lists. In some implementations, natural language processing may be used to summarize and/or normalize code change intents within each cluster, e.g., to generate a cluster-level or cluster-wide code change intent that captures all of the individual distinct code change intents of the cluster. In other implementations, rather than using natural language processing to group change lists having similar code change intents into clusters, source code snippets may be grouped into clusters using graph matching, e.g., on ASTs generated from the source code snippets.

Various training techniques may be employed to learn code change embeddings representing the plurality of change lists. For example, in some implementations, change graphs may be sampled from different clusters to train a machine learning model such as a neural network using techniques such as triplet loss. For example, triplet loss may involve: selecting an anchor (or “baseline”) change list from a change list cluster; sampling, as a positive or “truthy” input, another change list from the same change list cluster; and sampling, as a negative or “falsy” input, a change list from a different change list cluster. Triplet loss training may then be used to ensure that source code change embeddings generated from change lists having the syntactically and/or semantically similar underlying code change intents are closer to each other than other source code change embeddings generated from change lists having different code change intents.

Once the code change embeddings are learned—e.g., the neural network is trained to generate accurate embeddings—these embeddings may be used to train one or more natural language processing models to generate and/or predict code change intents. These natural language processing models may include various flavors of neural networks, such as feed-forward neural networks, recurrent neural networks, long short-term memory (“LSTM”) networks, gated recurrent unit (“GRU”) networks, transformer networks, bidirectional encoder representations, and any other network that can be trained to generate code change intents based on code change embeddings.

Once the code change embeddings are learned (e.g., a neural network is trained to generate code change embeddings from change graphs) and the natural language processing model(s) are also trained, these models may be used after or during an update of a to-be-updated software system code base for a variety of purposes. In some implementations, the trained machine learning model(s) may be used to generate a high-level summary of changes made to the code base. This high level summary may not have the redundant and/or repetitive entries of a “brute force” change list that simply includes all change list entries made by any team member who updated a code file. Rather, clustering semantically similar code changes together under a single change intent has the practical effect of deduplicating change intents in the change list.

Additionally or alternatively, in some implementations, the trained machine learning model may be used to automatically generate change list entries for programmers, who may be able to accept verbatim and/or edit the automatically-generated change list entries. For example, a change graph may be generated based on a change a programmer made to a source code file. The change graph may be applied as input across the model to generate an embedding in the latent space. This embedding will be proximate to other, semantically similar reference embeddings generated from past code changes. Change intent(s) associated with those proximate reference embeddings may then be used to generate a change intent for the programmer's updated source code file that is aligned with the change intent of the other semantically similar reference embeddings. In this way, it is possible to enforce or influence programmers to use best practices when composing change intents, as much of the work may be done for them.

In some implementations, a method performed by one or more processors is provided that includes: applying data indicative of a change made to source code snippet as input across a machine learning model to generate a new source code change embedding in a latent space; identifying one or more reference source code change embeddings in the latent space based on one or more distances between the one or more reference source code change embeddings and the new source code change embedding in the latent space, wherein each of the one or more reference source code change embeddings is generated by applying data indicative of a change, made to a reference first version source code snippet to yield a reference second version source code snippet, as input across the machine learning model; based on the identified one or more reference embeddings, identifying one or more code change intents; and creating an association between the source code snippet and the one or more code change intents.

In various implementations, the method may further include receiving an instruction to commit the change made to the source code snippet to a code base. In various implementations, at least the applying is performed in response to the instruction to commit the change made to the source code snippet to the code base. In various implementations, creating the association comprises automatically generating a change list entry based on one or more of the code change intents.

In various implementations, the method may further include automatically inserting, into the source code snippet, an embedded comment indicative of one or more of the code change intents. In various implementations, the data indicative of the change made to the source code snippet comprises an abstract syntax tree (“AST”). In various implementations, the data indicative of the change made to the source code snippet comprises a change graph. In various implementations, the machine learning model comprises a graph neural network (“GNN”).

In another aspect, a method implemented using one or more processors may include: obtaining data indicative of a change between a first version source code snippet and a second version source code snippet; obtaining data indicative of a change intent that was stored in memory in association with the change when the second version source code snippet was committed to a code base; applying the data indicative of the change as input across a machine learning model to generate a new code change embedding in a latent space; determining a distance in the latent space between the new code change embedding and a previous code change embedding in the latent space associated with the same change intent; and training the machine learning model based at least in part on the distance.

In various implementations, the distance may include a first distance, and the method may further include: determining a second distance in the latent space between the new code change embedding and another previous code change embedding in the latent space associated with a different change intent; and computing, using a loss function, an error based on the first distance and the second distance; wherein the training is based on the error.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be implemented, in accordance with various implementations.

FIG. 2 is a block diagram of an example process flow.

FIG. 3 schematically demonstrates one example of how latent space embeddings may be generated using machine learning models described here during an inference phase.

FIG. 4A and FIG. 4B depict example user interfaces that may be presented to programmers and/or software engineers using techniques described herein, in accordance with various implementations.

FIG. 5 depicts a flowchart illustrating an example method according to implementations disclosed herein.

FIG. 6 depicts a flowchart illustrating another example method according to implementations disclosed herein.

FIG. 7 depicts a flowchart illustrating another example method according to implementations disclosed herein.

FIG. 8 schematically depicts how data may be processed according to the method of FIG. 7.

FIG. 9 illustrates an example architecture of a computing device.

### DETAILED DESCRIPTION

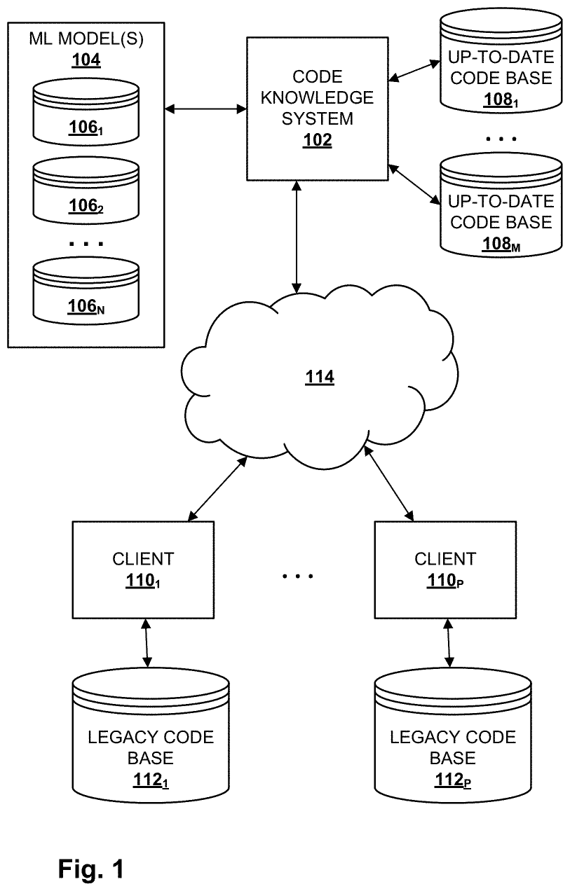

FIG. 1 schematically depicts an example environment in which selected aspects of the present disclosure may be implemented, in accordance with various implementations. Any computing devices depicted in FIG. 1 or elsewhere in the figures may include logic such as one or more microprocessors (e.g., central processing units or “CPUs”, graphical processing units or “GPUs”) that execute computer-readable instructions stored in memory, or other types of logic such as application-specific integrated circuits (“ASIC”), field-programmable gate arrays (“FPGA”), and so forth. Some of the systems depicted in FIG. 1, such as a code knowledge system 102, may be implemented using one or more server computing devices that form what is sometimes referred to as a “cloud infrastructure,” although this is not required.

Code knowledge system 102 may be configured to perform selected aspects of the present disclosure in order to help one or more clients 110_{1-P} to generate and/or utilize code change intents associated with the update (or “migration”) of one or more corresponding legacy code bases 112_{1-P}. Each client 110 may be, for example, an entity or organization such as a business (e.g., financial institute, bank, etc.), non-profit, club, university, government agency, or any other organization that operates one or more software systems. For example, a bank may operate one or more software systems to manage the money under its control, including tracking deposits and withdrawals, tracking loans, tracking investments, and so forth. An airline may operate one or more software systems for booking/canceling/rebooking flight reservations, managing delays or cancelations of flight, managing people associated with flights, such as passengers, air crews, and ground crews, managing airport gates, and so forth.

Many of these entities' code bases 112 may be highly complex, requiring teams of programmers and/or software engineers to perform code base migrations, maintenance, and/or updates. Many of these personnel may be under considerable pressure, and may place low priority on composing descriptive and/or helpful code change intents, in embedded comments or as part of change list entries. Accordingly, code knowledge system 102 may be configured to leverage knowledge of past code base migration, update, or maintenance events, and/past code change intents composed in association with these events, in order to automate composition and/or summarization of code change intents. Code change intents may be embodied in various forms, such as in change list entries that are sometimes required when an updated piece of code (referred to herein as a “source code snippet”) is committed (e.g., installed, stored, incorporated) into a code base, in comments (e.g., delimited with symbols such as “//” or “#”) embedded in the source code, in change logs, or anywhere else where human-composed language indicating an intent behind a source code change might be found.

In various implementations, code knowledge system 102 may include a machine learning (“ML” in FIG. 1) database 104 that includes data indicative of one or more trained machine learning models 106_{1-N}. These trained machine learning models 106_{1-N} may take various forms that will be described in more detail below, including but not limited to a graph neural network (“GNN”), a sequence-to-sequence model such as various flavors of a recurrent neural network (e.g., long short-term memory, or “LSTM”, gate recurrent units, or “GRU”, etc.) or an encoder-decoder, and any other type of machine learning model that may be applied to facilitate selected aspects of the present disclosure.

In some implementations, code knowledge system 102 may also have access to one or more up-to-date code bases 108_{1-M}. In some implementations, these up-to-date code bases 108_{1-M} may be used, for instance, to train one or more of the machine learning models 106_{1-N}. In some such implementations, and as will be described in further detail below, the up-to-date code bases 108_{1-M} may be used in combination with other data to train machine learning models 106_{1-N}, such as non-up-to-date code bases (not depicted) that were updated to yield up-to-date code bases 108_{1-M}. “Up-to-date” as used herein is not meant to require that all the source code in the code base be the absolute latest version. Rather, “up-to-date” may refer to a desired state of a code base, whether that desired state is the most recent version code base, the most recent version of the code base that is considered “stable,” the most recent version of the code base that meets some other criterion (e.g., dependent on a particular library, satisfies some security protocol or standard), etc.

In various implementations, a client 110 that wishes to take advantage of techniques described herein for generating and/or utilizing code change intents when migrating, updating, or even maintaining its legacy code base 112 may establish a relationship with an entity (not depicted in FIG. 1) that hosts code knowledge system 102. In some implementations, code knowledge system 102 may then monitor changes made to all or parts of the client's source code base 112, e.g., by interfacing with the client's software development version control system (not depicted) over one or more networks 114 such as the Internet. Based on this monitoring, code knowledge system 102 may perform various techniques described herein for generating and/or utilizing code change intents. In other implementations, e.g., where the client's code base 112 is massive, one or more representatives of the entity that hosts code knowledge system 102 may travel to the client's site(s) to perform updates and/or make recommendations.

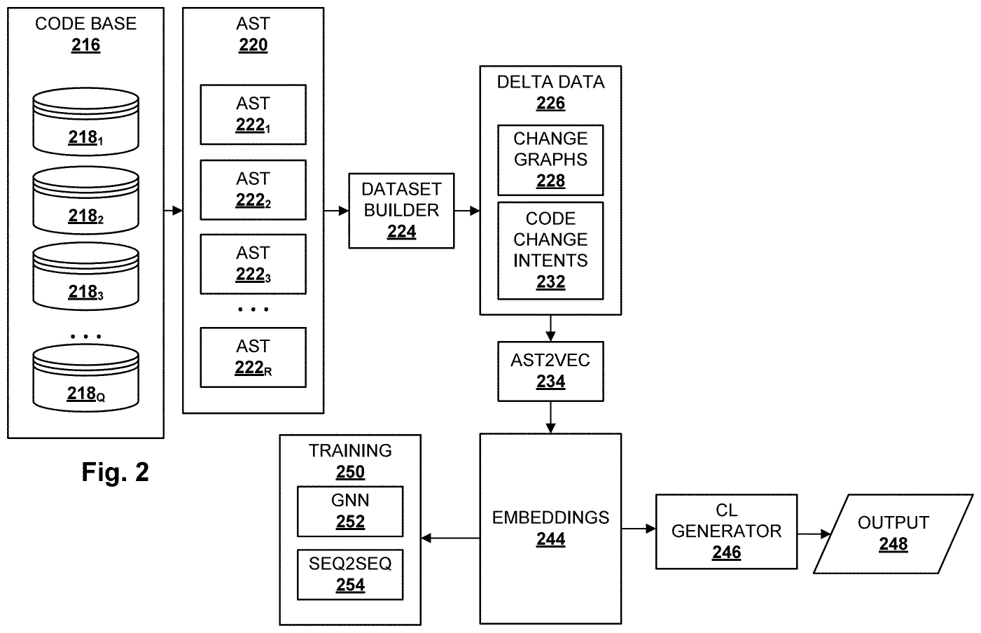

FIG. 2 is a block diagram of example process flow(s) that may be implemented in whole or in part by code knowledge system 102, during training of machine learning models 106_{1-N} and/or during use of those models (“inference”) to generate and/or utilize code change intents. Training will be discussed first, followed by inference. Unless otherwise indicated, various components in FIG. 2 may be implemented using any combination of hardware and computer-readable instructions.

Beginning at the top left, a codebase 216 may include one or more source code snippets 218_{1-Q} of one or more types. For example, in some cases a first source code snippet 218₁ may be written in Python, another source code snippet 218₂ may be written in Java, another 218₃ in C/C++, and so forth. Additionally or alternatively, each of elements 218_{1-Q} may represent one or more source code snippets from a particular library, entity, and/or application programming interface (“API”). Each source code snippet 218 may comprise a subset of a source code file or an entire source code file, depending on the circumstances. For example, a particularly large source code file may be broken up into smaller snippets (e.g., delineated into functions, objects, etc.), whereas a relatively short source code file may be kept intact throughout processing.

At least some of the source code snippets 218_{1-Q} of code base 112 may be converted into an alternative form, such as a graph or tree form, in order for them to be subjected to additional processing. For example, in FIG. 2, source code snippets 218_{1-Q} are processed to generate abstract syntax trees (“AST”) 222_{1-R}. Q and R may both be positive integers that may or may not be equal to each other. As noted previously, an AST may represent constructs occurring in a given source code snippet, such as variables, objects, functions, etc., as well as the syntactic and/or semantic relationships between these components. In some implementations, ASTs 220 may include a first AST for a first version of a source code snippet (e.g., the “to-be-updated” version), another AST for a second version of the source code snippet (e.g., the “target version”), and a third AST that conveys the difference(s) between the first source code snippet and the second source code snippet.

A dataset builder 224, which may be implemented using any combination of hardware and machine-readable instructions, may receive the ASTs 222_{1-R} as input and generate, as output, various different types of data that may be used for various purposes in downstream processing. For example, in FIG. 2, dataset builder 224 generates, as “delta data” 226, change graphs 228, AST-AST data 230, and code change intents 232. Change graphs 228—which as noted above may themselves take the form of ASTs—may include one or more change graphs generated from one or more pairs of ASTs generated from respective pairs of to-be-updated/target source code snippets. Put another way, each source code snippet 218 may be mapped to an AST 222. Pairs of ASTs, one representing a first version of a source code snippet and another representing a second version of the source code snippet, may be mapped to a change graph 228. Each change graph 228 therefore represents one or more changes made to update a source code snippet from a first (to-be-updated) version to a second (target) version. In some implementations, a distinct change graph may be generated for each change to the source code snippet during its evolution from the first version to the second version.

Code change intents 232 may be assigned to change graphs 228 for training purposes. Each code change intent 232 may include text that conveys the intent of the software engineer or programmer when they changed/edited the source code snippet underlying the change graph under consideration. For example, each of change graphs 228 may be labeled with a respective code change intent of code change intents 232. The respective code change intents may be used to map the changes conveyed by the change graphs 228 to respective regions in a latent space. For example, a code change intent “migrate from language_A to language_B” may be applied to one change of a source code snippet, another code change intent, “link to more secure encryption library,” may be applied to another change of another source code snippet, and so on.

An AST2VEC component 234 may be configured to generate, from delta data 226, one or more feature vectors, i.e. “latent space” embeddings 244. For example, AST2VEC component 234 may apply change graphs 228 as input across one or more machine learning models to generate respective latent space embeddings 244. The machine learning models may take various forms as described previously, such as a GNN 252, a sequence-to-sequence model 254 (e.g., an encoder-decoder), etc.

During training, a training module 250 may train a machine learning model such as GNN 252 or sequence-to-sequence model 254 to generate embeddings 244 based directly or indirectly on source code snippets 218_{1-Q}. These embeddings 244 may capture semantic and/or syntactic properties of the source code snippets 218_{1-Q}, as well as a context in which those snippets are deployed. In some implementations, as multiple change graphs 228 are input across the machine learning model (particularly GNN 252), the code change intents 232 assigned to them may be used as part of a loss function that determines whether comparable changes are clustering together properly in the latent space.

Suppose an embedding generated from a source code change motivated by a particular code change intent (e.g., “link to more secure encryption library”) is not sufficiently proximate to other embeddings having the same or similar code change intent (e.g., is closer to embeddings of other code change intents). GNN 252 may be trained, e.g., using techniques such as gradient descent and back propagation (e.g., as part of a triplet loss training procedure). This training process may be repeated over numerous training examples until GNN 252 is able to accurately map change graphs, and more generally, data structures representing source code changes, to regions in the latent space near other, syntactically/semantically similar data structures.

With GNN 252 in particular, the constituent ASTs of delta data 226, which recall were generated from the source code snippets and may include change graphs in the form of ASTs, may be operated on as follows. Features (which may be manually selected or learned during training) may be extracted for each node of the AST to generate a feature vector for each node. Recall that nodes of the AST may represent a variable, object, or other programming construct. Accordingly, features of the feature vectors generated for the nodes may include features like variable type (e.g., int, float, string, pointer, etc.), name, operator(s) that act upon the variable as operands, etc. A feature vector for a node at any given point in time may be deemed that node's “state.”

Meanwhile, each edge of the AST may be assigned a machine learning model, e.g., a particular type of machine learning model or a particular machine learning model that is trained on particular data. For example, edges representing “if” statements may each be assigned a first neural network. Edges representing “else” statements also may each be assigned the first neural network. Edges representing conditions may each be assigned a second neural network. And so on.

Then, for each time step of a series of time steps, feature vectors, or states, of each node may be propagated to their neighbor nodes along the edges/machine learning models, e.g., as projections into latent space. In some implementations, incoming node states to a given node at each time step may be summed (which is order-invariant), e.g., with each other and the current state of the given node. As more time steps elapse, a radius of neighbor nodes that impact a given node of the AST increases.

Intuitively, knowledge about neighbor nodes is incrementally “baked into” each node's state, with more knowledge about increasingly remote neighbors being accumulated in a given node's state as the machine learning model is iterated more and more. In some implementations, the “final” states for all the nodes of the AST may be reached after some desired number of iterations is performed. This number of iterations may be a hyper-parameter of GNN 252. In some such implementations, these final states may be summed to yield an overall state or embedding (e.g., 244) of the AST.

In some implementations, for change graphs 228, edges and/or nodes that form part of the change may be weighted more heavily during processing using GNN 252 than other edges/nodes that remain constant across versions of the underlying source code snippet. Consequently, the change(s) between the versions of the underlying source code snippet may have greater influence on the resultant state or embedding representing the whole of the change graph 228. This may facilitate clustering of embeddings generated from similar code changes in the latent space, even if some of the contexts surrounding these embeddings differ somewhat.

For sequence-to-sequence model 254, training may be implemented using implicit labels that are manifested in a sequence of changes to the underlying source code. Rather than training on source and target ASTs, it is possible to train using the entire change path from a first version of a source code snippet to a second version of the source code snippet. For example, sequence-to-sequence model 254 may be trained to predict, based on a sequence of source code elements (e.g., tokens, operators, etc.), an “updated” sequence of source code elements that represent the updated source code snippet. In some implementations, both GNN 252 and sequence-to-sequence model 254 may be employed, separately and/or simultaneously.

Once the machine learning models (e.g., 252-254) are adequately trained, they may be used during an inference phase to help generate code change intents and/or to map code changes to code change intents, e.g., for change list summarization purposes. During inference, many of the operations of FIG. 2 operate similarly as in training.

The source code snippets 218_{1-Q} are once again used to generate ASTs 222_{1-R}, which are processed by dataset builder 224 to generate change graphs 228. These change graphs 228 are applied by AST2VEC component 234 as input across one or more of the trained machine learning models (e.g., 252, 254) to generate new source code change embeddings 244 in latent space. Then, one or more reference source code change embeddings in the latent space may be identified, e.g., by a change list (“CL”) generator 246, based on respective distances between the one or more reference source code change embeddings and the new source code change embedding in the latent space.

Based on the identified one or more reference source code change embeddings, CL generator 246 may identify (e.g., predict) one or more code change intents, e.g., which may be associated with the reference source code change embeddings themselves and/or associated with a region of latent space containing a cluster of similar reference source code change embeddings. These identified code change intents may be output at block 248. In some implementations, if a code change intent is identified with a sufficient measure of confidence, the code change intent may be automatically associated with the updated source code snippet 218, e.g., as a change list entry. A code change intent with a lesser measure of confidence may be presented to the user for editing and/or approval before it is associated with the updated source code snippet.

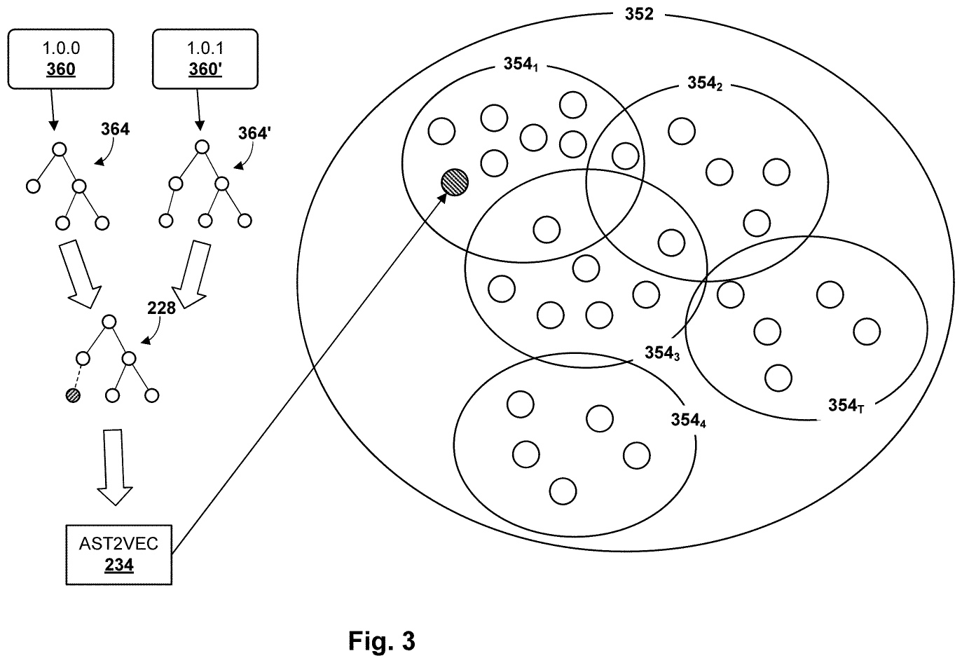

FIG. 3 depicts one example of how a source code snippet 360 may be used to create a reference embedding and/or to train a machine learning model, such as GNN 252. The first version of source code snippet 360 is, in this example, 1.0.0. The second, updated version of source code snippet 360′ is, in this example, 1.0.1. As shown in FIG. 3, ASTs 364, 364′ may be generated, respectively, from the first and second versions of the source code snippet, 360, 360′. Assume for this example that the only change to the source code snippet between 1.0.0 and 1.0.1 is reflected in the addition of a new node at bottom left of AST 364′.

ASTs 364, 364′ may be compared, e.g., by dataset builder 224, to generate a change graph 228 that reflects this change. Change graph 228 may then be processed, e.g., by AST2VEC 234 using a machine learning model such as GNN 252 and/or sequence-to-sequence model 254, to generate a latent space embedding as shown by the arrow. In this example, the latent space embedding falls with a region 354₁ of latent space 352 in which other reference embeddings (represented in FIG. 3 again by small circles) that involved similar code changes are also found.

As part of training the machine learning model, in some implementations, data indicative of a change between a first version source code snippet and a second version source code snippet, e.g., change graph 228, may be labeled (with 232) with a code change intent, which may be obtained from a change list entry, embedded comment, etc. Change graph 228 may then be applied, e.g., by AST2VEC component 234, as input across a machine learning model (e.g., 252) to generate a new source code change embedding in latent space 352. Next, a distance in the latent space between the new source code change embedding and a previous (e.g., reference) source code change embedding in the latent space associated with the same code change intent may be determined and used to train the machine learning model. For example, if the distance is too great—e.g., greater than a distance between the new source code change embedding and a reference source code change embedding of a different code change intent—then techniques such as back propagation and gradient descent may be applied to alter weight(s) and/or parameters of the machine learning model. This training technique may be referred to as “triplet loss.” Eventually after enough training, reference embeddings having the same or similar underlying code change intents will cluster together in latent space 352.

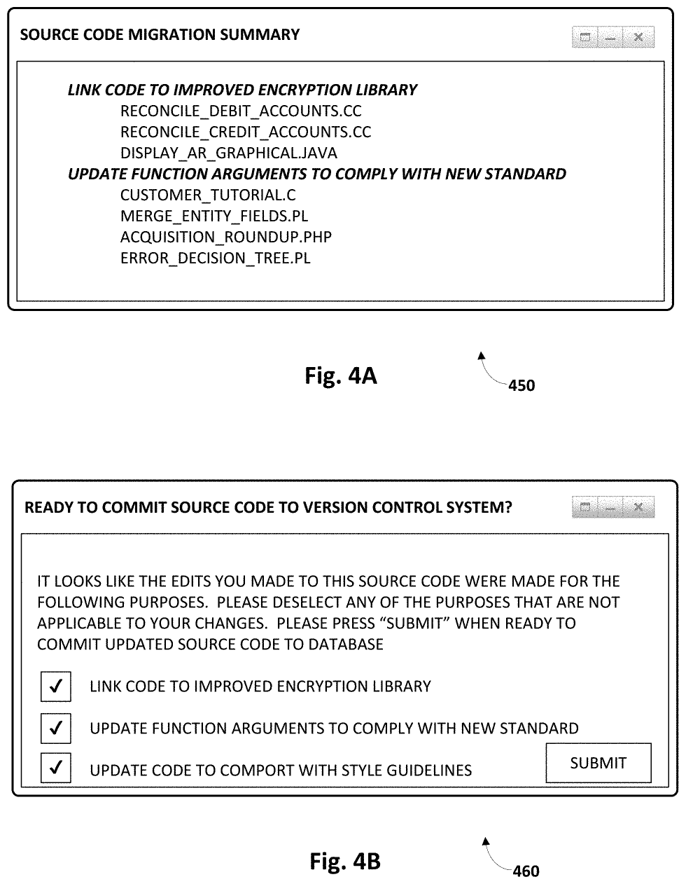

FIGS. 4A and 4B depict two examples of how techniques described herein may be applied during the inference phase, in accordance with various implementations. In FIG. 4A, a graphical user interface (“GUI”) 450 is entitled “SOURCE CODE MIGRATION SUMMARY,” and includes a list of code change intents and source code files that were edited in association with (e.g., in response to) those code change intents. To generate GUI 450, source code files (or more generally, source code snippets) may be mapped to regions of latent space that correspond to code change intents as described above.

For example, a first code change intent, “Link code to improved encryption library,” is designated as the code change intent that motivated edits made to three source code files, “RECONCILE_DEBIT_ACCOUNTS.CC,” “RECONCILE_CREDIT_ACCOUNTS.CC,” and “DISPLAY_AR_GRAPHICAL.JAVA.” When these three source code files were processed as described above, their respective source code change embeddings may have been clustered together near each other and/or other reference source code change embeddings that were all associated with the intent by programmers/software engineers of linking code to an improved encryption library.

A second code change intent, “Update function arguments to comply with new standard,” is designated as the code change intent that motivated edits make to four source code files, “CUSTOMER_TUTORIAL.C,” “MERGE_ENTITY_FIELDS.PL,” “ACQUISITION_ROUNDUP.PHP,” and “ERROR_DECISION_TREE.PL.” When these three source code files were processed as described above, their respective source code change embeddings may have been clustered together near each other and/or other reference source code change embeddings that were all associated with the intent by programmers/software engineers of updating function arguments to comply with the new standard.

FIG. 4B depicts another GUI 460 entitled “READY TO COMMIT SOURCE CODE TO VERSION CONTROL SYSTEM?” that may be generated using techniques described herein. GUI 460 may be presented when, for example, a programmer or software engineer has edited a source code snippet, and is ready to commit the updated source code snippet to the code base. For example, the updated source code snippet and its previous version may be used to generate ASTs that are then used to generate a change graph. This change graph may be applied as input across the trained machine learning model (e.g., GNN 252) to generate a new source code change embedding. Distance(s) between the new source code change embedding and other, reference embeddings in latent space may be determined. One or more code change intents associated with one or more neighbors (e.g., n nearest neighbors, wherein n is a positive integer) may then be identified and used to automatically generate code change intents for the updated source code.

In FIG. 4B, GUI 460 informs the user, “It looks like the edits you made to this source code were made for the following purposes. Please deselect any of the purposes that are not applicable to your changes. The source code change implemented by the user is mapped to three different code change intents: “link code to improved encryption library,” “update function arguments to comply with new standard,” and “update code to comport with style guidelines.” All three code change intents are provisionally selected, e.g., with the check boxes depicted at left, as motivating the change(s) the user made to the source code snippet. The user has the option of deselecting one or more of the check boxes to indicate that the corresponding intent was not a motivation behind the user's editing of the source code snippet. When the user is satisfied that the proper code change intents that motivated the user's behavior are selected he or she may press submit to commit the code to the code base. In some implementations, whether the user selects or deselects these boxes may be used as additional training data for training, e.g., GNN 252.

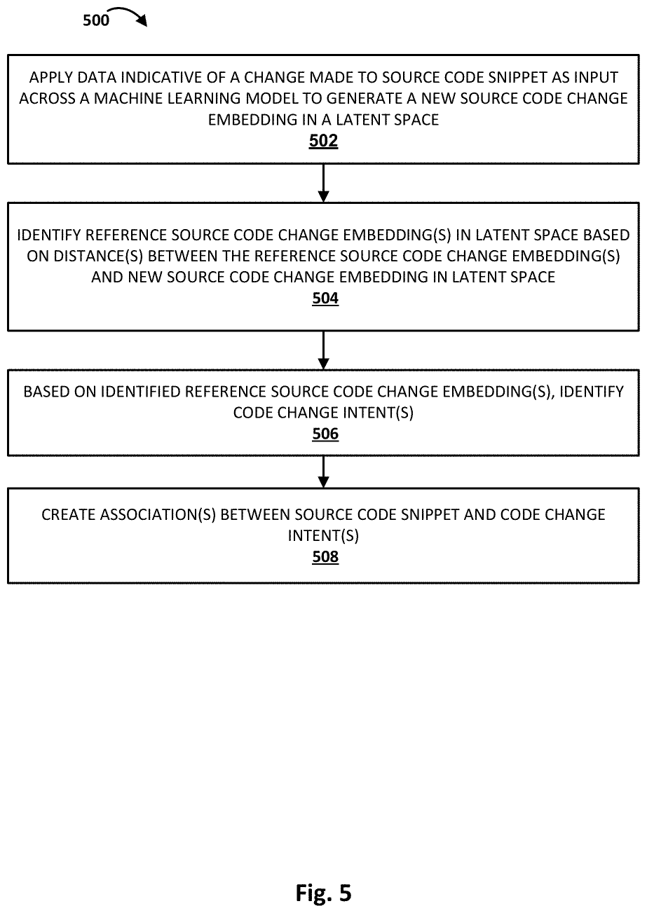

FIG. 5 is a flowchart illustrating an example method 500 of utilizing a trained machine learning model to associated updated source code snippets to code change intents, in accordance with implementations disclosed herein. For convenience, the operations of the flow chart are described with reference to a system that performs the operations. This system may include various components of various computer systems, such as one or more components of code knowledge system 102. Moreover, while operations of method 500 are shown in a particular order, this is not meant to be limiting. One or more operations may be reordered, omitted or added.

At block 502, the system may apply data indicative of a change made to source code snippet as input across a machine learning model (e.g., GNN 252) to generate a new source code change embedding in a latent space. An example of this occurring was depicted in FIG. 3, in which “before” and “after” versions of a source code snippet were used to first generate respective ASTs, and then a change graph. The change graph was then applied as input across the trained machine learning model to generate the new source code change embedding. Although not depicted in FIG. 5, in some implementations, the applying of block 502 (as well as one or more of the subsequent operations 504-508) may be performed in response to receipt, e.g., as a version control system, of an instruction to commit a change made to the source code snippet to a code base.

At block 504, the system may identify one or more reference source code change embeddings in the latent space based on one or more distances between the one or more reference source code change embeddings and the new source code change embedding in the latent space. Each of the one or more reference source code change embeddings may have been generated previously by applying data indicative of a change, made to a reference first version source code snippet to yield a reference second version source code snippet, as input across the machine learning model. For example, in some implementations, the system may identify reference source code change embeddings that are within some threshold distance from the new source code change embedding in latent space. These distances may be determined using techniques such as the dot product, cosine similarity, etc.

Based on the one or more reference embeddings identified at block 504, at block 506, the system may identify one or more code change intents. For example, the reference source code change embeddings may be associated, e.g., in a lookup table or database, with code change intents. In some implementations, a region of latent space may be associated with (e.g., assigned) a code change intent, and any source code change embedding that is located within that region may be considered to have that code change intent.

At block 508, the system may create an association between the source code snippet and the one or more code change intents. In some implementations, creating this association may include automatically generating a change list entry based on one or more of the code change intents, e.g., as depicted in FIG. 4B. Additionally or alternatively, in some implementations, creating the association may include automatically inserting, into the source code snippet (e.g., in front of a function, in line with the changed code), an embedded comment indicative of one or more of the code change intents. The updated source code snippet, with this embedded comment added, may then be committed to the code base.

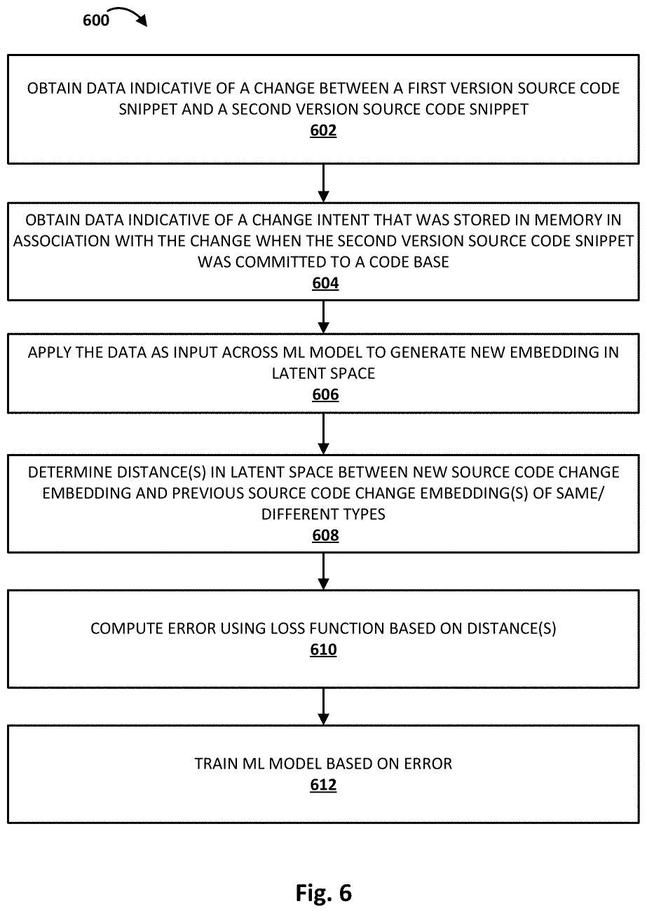

FIG. 6 is a flowchart illustrating an example method 600 of training a machine learning model such as GNN 252 to map source code changes to a latent space that contains reference source code change embeddings, in accordance with implementations disclosed herein. For convenience, the operations of the flow chart are described with reference to a system that performs the operations. This system may include various components of various computer systems, such as one or more components of code knowledge system 102. Moreover, while operations of method 600 are shown in a particular order, this is not meant to be limiting. One or more operations may be reordered, omitted or added.

At block 602, the system may obtain data indicative of a change between a first version source code snippet and a second version source code snippet. For example, a change graph 228 may be generated, e.g., by dataset builder 224, based on “before” and “after” versions of the source code snippet. At block 604, the system, e.g., by way of dataset builder 224, may obtain data indicative of a change intent that was stored in memory in association with the change when the second version source code snippet was committed to a code base. This code change intent may be found, for instance, within the source code as an embedded comment or in a change list entry.

At block 606, the system may apply the data indicative of the change (e.g., change graph 228) as input across a machine learning model, e.g., GNN 252, to generate a new embedding in a latent space. At block 608, the system may determine distance(s) in the latent space between the new embedding and previous embedding(s) in the latent space associated with the same and/or different change types. These distances may be computed using techniques such as cosine similarity, dot product, etc.

At block 610, the system may compute an error using a loss function and the distance(s) determined at block 608. For example, if a new source code change embedding having a code change intent “upgrade to 5G library” is closer to previous source code change embedding(s) of the type “link to new template library” than it is to previous embeddings of the type “upgrade to 5G library,” that may signify that the machine learning model that generated the new embedding needs to be updated, or trained. Accordingly, at block 612, the system may train the machine learning model based at least in part on the error computed at block 610. The training of block 612 may involve techniques such as gradient descent and/or back propagation. Additionally or alternatively, in various implementations, other types of labels and/or training techniques may be used to train the machine learning model, such weak supervision or triplet loss, which may include the use of labels such as similar/dissimilar or close/not close.

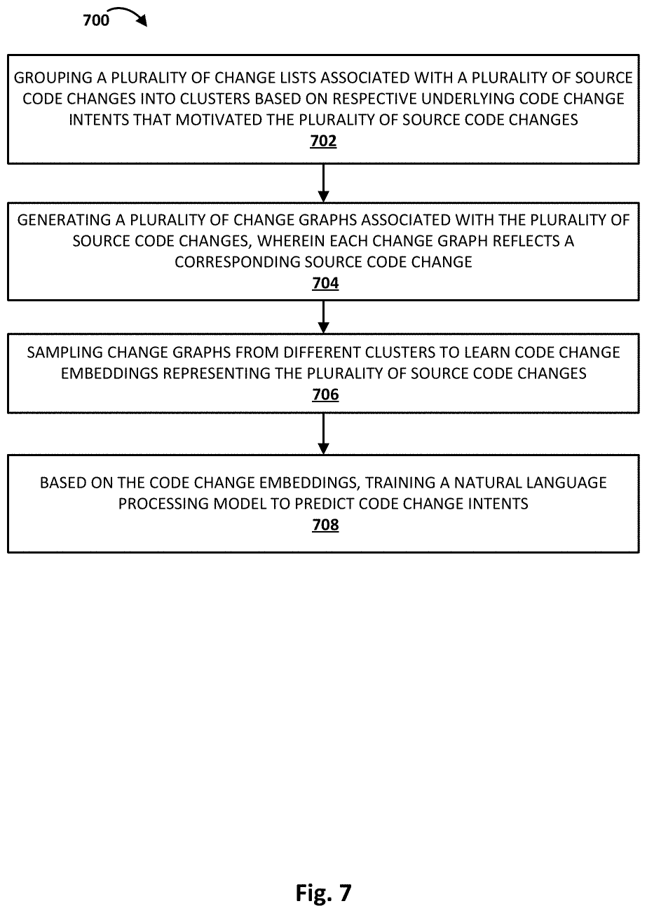

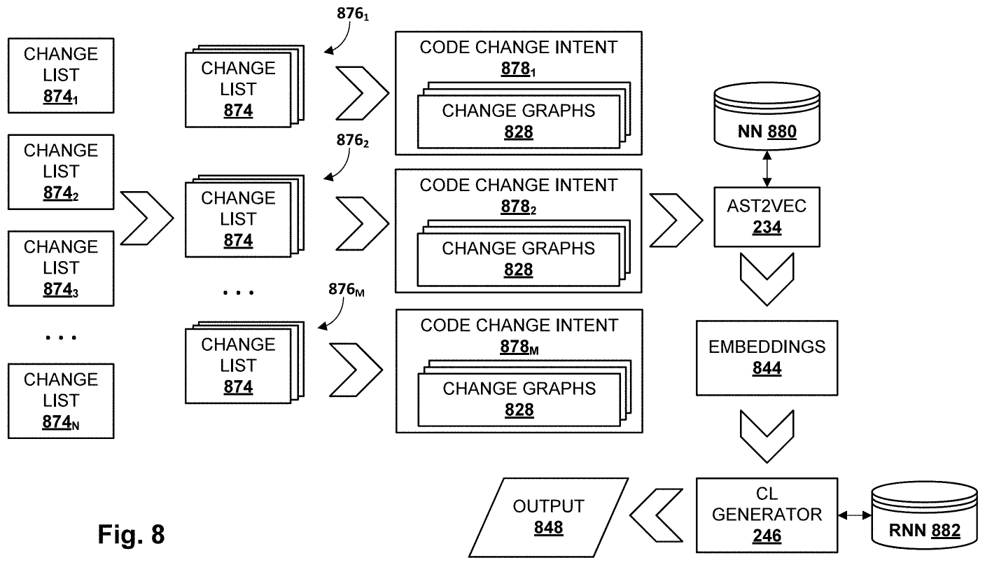

FIG. 7 is a flowchart illustrating an example method 700 of learning code change embeddings by sampling from clusters of change lists that are semantically and/or syntactically similar, and using these learned embeddings to predict code change intents, in accordance with implementations disclosed herein. For convenience, the operations of the flow chart are described with reference to a system that performs the operations. This system may include various components of various computer systems, such as one or more components of code knowledge system 102. Moreover, while operations of method 700 are shown in a particular order, this is not meant to be limiting. One or more operations may be reordered, omitted or added. The flow of data controlled by the operations of FIG. 7 is depicted schematically in FIG. 8.

Referring to both FIGS. 7 and 8, at block 702, the system may group a plurality of change lists 874_{1-N} associated with a plurality of source code changes into a plurality of clusters 876_{1-M} (N and M both being positive integers). This grouping may be based on respective underlying code change intents that motivated the plurality of source code changes. In some implementations, the respective underlying code change intents may be analyzed using natural language processing to identify syntactically and/or semantically similar code change intents, so that the change lists underlying the syntactically and/or semantically similar code change intents can be clustered together.

At block 704, the system may generate a plurality of change graphs 828 associated with the plurality of source code changes. Each change graph 828 may reflects a corresponding source code change. In FIG. 8, each cluster 876 is associated with (as indicated by the chevron) a corresponding code change intent 878. As a result of the operations of block 704, each code change intent thus includes one or more change graphs 828 associated with the underlying change lists of that cluster.

At block 706, the system, e.g., by way of AST2VEC component 234, may sample change graphs 828 from different clusters 874 to learn code change embeddings 844 representing the plurality of source code changes. In some implementations, these learned embeddings may be incorporated into a GNN, such as GNN 252 described previously, or may be incorporated into a feed-forward neural network. In some implementations, the sampling of block 706 may be performed using techniques such as triplet loss, and may include sampling an anchor input and a positive input from a first cluster of the plurality of clusters, and sampling a negative input from a second cluster of the plurality of clusters. Respective distances between the anchor input and the positive and negative inputs may then be used to train, for instance, GNN 252 and/or another machine learning model, such as a feed-forward neural network.

At block 708, the system, e.g., by way of CL generator 246 or another similar component, may use the learned code change embeddings to train a natural language processing model 882 to predict code change intents (output 848). In FIG. 8, the natural language processing model 882 takes the form of a recurrent neural network (“RNN”). However, this is not meant to be limiting. In various implementations, other types of natural language machine learning models, such as LSTM networks, GRU networks, transformer networks, and so forth, may be used to predict code change intents from code change embeddings 844.

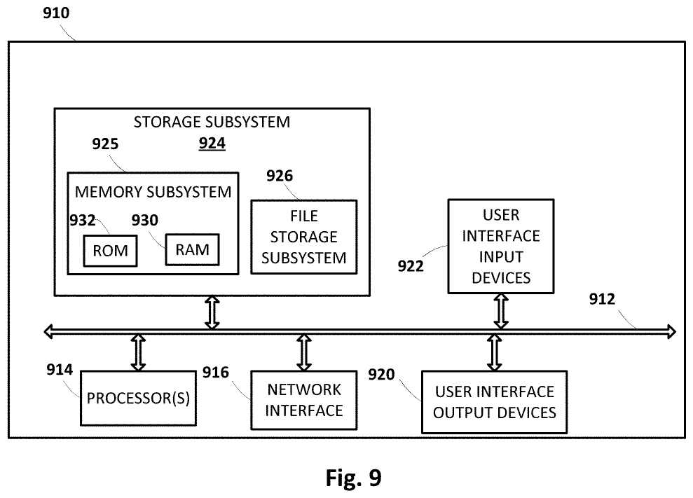

FIG. 9 is a block diagram of an example computing device 910 that may optionally be utilized to perform one or more aspects of techniques described herein. Computing device 910 typically includes at least one processor 914 which communicates with a number of peripheral devices via bus subsystem 912. These peripheral devices may include a storage subsystem 924, including, for example, a memory subsystem 925 and a file storage subsystem 926, user interface output devices 920, user interface input devices 922, and a network interface subsystem 916. The input and output devices allow user interaction with computing device 910. Network interface subsystem 916 provides an interface to outside networks and is coupled to corresponding interface devices in other computing devices.

User interface input devices 922 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 910 or onto a communication network.

User interface output devices 920 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 910 to the user or to another machine or computing device.

Storage subsystem 924 stores programming and data constructs that provide the functionality of some or all of the modules described herein. For example, the storage subsystem 924 may include the logic to perform selected aspects of the methods of FIGS. 5-6, as well as to implement various components depicted in FIGS. 1-2.

These software modules are generally executed by processor 914 alone or in combination with other processors. Memory 925 used in the storage subsystem 924 can include a number of memories including a main random access memory (RAM) 930 for storage of instructions and data during program execution and a read only memory (ROM) 932 in which fixed instructions are stored. A file storage subsystem 926 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 926 in the storage subsystem 924, or in other machines accessible by the processor(s) 914.

Bus subsystem 912 provides a mechanism for letting the various components and subsystems of computing device 910 communicate with each other as intended. Although bus subsystem 912 is shown schematically as a single bus, alternative implementations of the bus subsystem may use multiple busses.

Computing device 910 can be of varying types including a workstation, server, computing cluster, blade server, server farm, or any other data processing system or computing device. Due to the ever-changing nature of computers and networks, the description of computing device 910 depicted in FIG. 9 is intended only as a specific example for purposes of illustrating some implementations. Many other configurations of computing device 910 are possible having more or fewer components than the computing device depicted in FIG. 9.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors, comprising:
applying data indicative of a change made to source code snippet as input across a machine learning model to generate a new source code change embedding in a latent space;
identifying one or more reference source code change embeddings in the latent space based on one or more distances between the one or more reference source code change embeddings and the new source code change embedding in the latent space, wherein each of the one or more reference source code change embeddings is generated by applying data indicative of a change, made to a reference first version source code snippet to yield a reference second version source code snippet, as input across the machine learning model;
based on the identified one or more reference embeddings, identifying one or more code change intents; and
creating an association between the source code snippet and the one or more code change intents.

2. The method of claim 1, further comprising receiving an instruction to commit the change made to the source code snippet to a code base.

3. The method of claim 2, wherein at least the applying is performed in response to the instruction to commit the change made to the source code snippet to the code base.

4. The method of claim 3, wherein creating the association comprises automatically generating a change list entry based on one or more of the code change intents.

5. The method of claim 1, further comprising automatically inserting, into the source code snippet, an embedded comment indicative of one or more of the code change intents.

6. The method of claim 1, wherein the data indicative of the change made to the source code snippet comprises an abstract syntax tree (“AST”).

7. The method of claim 1, wherein the data indicative of the change made to the source code snippet comprises a change graph.

8. The method of claim 1, wherein the machine learning model comprises a graph neural network (“GNN”).

9. A method implemented using one or more processors, comprising:
obtaining data indicative of a change between a first version source code snippet and a second version source code snippet;
obtaining data indicative of a change intent that was stored in memory in association with the change when the second version source code snippet was committed to a code base;
applying the data indicative of the change as input across a machine learning model to generate a new code change embedding in a latent space;
determining a distance in the latent space between the new code change embedding and a previous code change embedding in the latent space associated with the same change intent; and
training the machine learning model based at least in part on the distance.

10. The method of claim 9, wherein the distance comprises a first distance, and the method further comprises:
determining a second distance in the latent space between the new code change embedding and another previous code change embedding in the latent space associated with a different change intent; and
computing, using a loss function, an error based on the first distance and the second distance;
wherein the training is based on the error.

11. The method of claim 9, wherein the machine learning model comprises a graph neural network (“GNN”).

12. The method of claim 9, wherein the data indicative of the change comprises a change graph.

13. The method of claim 12, wherein the change graph is generated from a first abstract syntax tree (“AST”) generated from the first version source code snippet and a second AST generated from the second version source code snippet.

14. The method of claim 9, wherein the data indicative of the change comprises a change graph.

15. The method of claim 9, wherein the data indicative of the change intent comprises a change list entry.

16. The method of claim 9, wherein the data indicative of the change intent comprises a comment embedded in the second version source code snippet.

17. A method implemented using one or more processors, the method comprising:
grouping a plurality of change lists associated with a plurality of source code changes into clusters based on respective underlying code change intents that motivated the plurality of source code changes;
generating a plurality of change graphs associated with the plurality of source code changes, wherein each change graph reflects a corresponding source code change;
sampling change graphs from different clusters to learn code change embeddings representing the plurality of source code changes; and
based on the code change embeddings, training a natural language processing model to predict code change intents.

18. The method of claim 17, wherein the sampling comprises sampling an anchor input and a positive input from a first cluster of the plurality of clusters, and sampling a negative input from a second cluster of the plurality of clusters.

19. The method of claim 17, wherein to learn the code change embeddings includes training a graph neural network (“GNN”).

20. The method of claim 17, wherein the natural language processing model comprises a recurrent neural network or a transformer network.
